(19) United States
(12) Patent Application Publication
(10) Pub. No.: US 2017/0134064 A1
(43) Pub. Date: May 11, 2017

(54) APPARATUS FOR CARRYING A PORTABLE ELECTRONIC DEVICE

(71) Applicant: Joaquin Rodriguez, San Juan, TX (US)

(72) Inventor: Joaquin Rodriguez, San Juan, TX (US)

(21) Appl. No.: 15/256,385

(22) Filed: Sep. 2, 2016

Related U.S. Application Data
(60) Provisional application No. 62/213,604, filed on Sep. 2, 2015.

(51) Int. Cl. H04B 1/3888; H04M 1/02

(52) U.S. Cl. CPC H04B 1/3888; H04M 1/0202

(57) ABSTRACT

A device for storing one or more phone accessories is provided. The device may include: a case having one or more earphones cavities to hold one or more earphones; one or more apertures stored on the case to operate a camera; and one or more channels stored on the case to wrap up one or more wires of the earphones.

### CROSS-REFERENCES TO RELATED APPLICATIONS

The present application claims the benefit of U.S. Provisional Application No. 62/213,604, entitled “PHONE EATERS,” filed on Sep. 2, 2015, which is hereby incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE TECHNOLOGY

The present disclosure generally relates to the field of portable electronic device cases and, more specifically, to apparatus and system for holding a cellular phone together with the earphones and storage and retraction of headset cords.

### DESCRIPTION OF THE RELATED ART

As portable electronic devices become smaller and more sophisticated, they are prone to being easily damaged. Some of the portable electronic devices are fitted with accessories for performing extended functions, but lack capabilities for a complete solution.

The smartphone accessories and tablets available on the market do not adequately address accessories for performing extended functions. In particular, the designs are either not aesthetically pleasing or not functionally sound. As such, multiple types of covers must be employed, alone or in conjunction, to achieve optimal satisfaction.

Therefore, what is needed is a case and an accessory housing that provides protection for a portable device and to hold accessories of the portable phone.

### SUMMARY

In an embodiment, a device for storing one or more phone accessories is provided. The system may include: a case having one or more earphones cavities to hold one or more earphones; one or more apertures stored on the case to operate a camera; and one or more channels stored on the case to wrap up one or more wires of the earphones.

In yet another embodiment, an apparatus for storing one or more phone accessories is provided. The apparatus may include: a case having one or more earphones cavities to hold one or more earphones; one or more apertures stored on the case to operate a camera; and one or more channels stored on the case to wrap up one or more wires of the earphones.

In still another embodiment, a means for storing one or more phone accessories is provided. The means may include: a means for holding a portable electronic device; a means for holding the earphones; a means for operating a camera; and a means for wrapping up the wires of the earphones.

### BRIEF DESCRIPTION OF THE DRAWINGS

The present invention is described in detail below with reference to the attached drawing figures, which are incorporated by reference herein and wherein:

FIG. 1A is a block diagram illustrating an exemplary embodiment of the invention;

FIG. 1B is a block diagram in accordance with another exemplary embodiment of the invention;

FIG. 2 is a block diagram with earphones in accordance with another exemplary embodiment of the invention; and

FIG. 3 is a flowchart illustrating a process in accordance with exemplary embodiments of the invention.

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent application, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent application (other than the language of the claims). To the extent that any term recited in the claims at the end of this patent application is referred to in this patent application in a manner consistent with a single meaning, that is done for sake of clarity only so as to not confuse the reader, and it is not intended that such claim term by limited, by implication or otherwise, to that single meaning Finally, unless a claim element is defined by reciting the word “means” and a function without the recital of any structure, it is not intended that the scope of any claim element be interpreted based on the application of 35 U.S.C. §112, sixth paragraph.

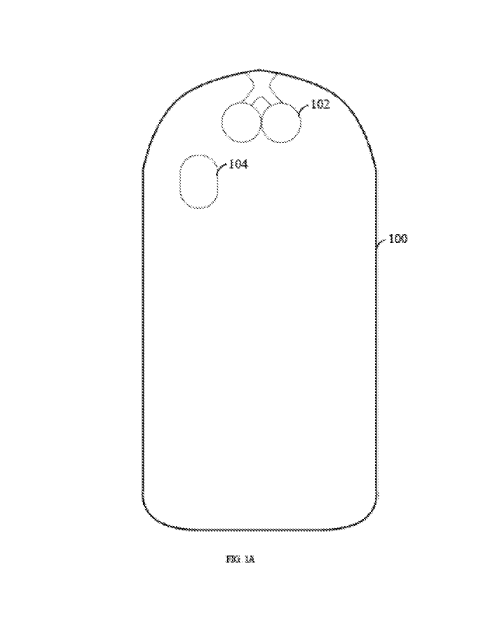

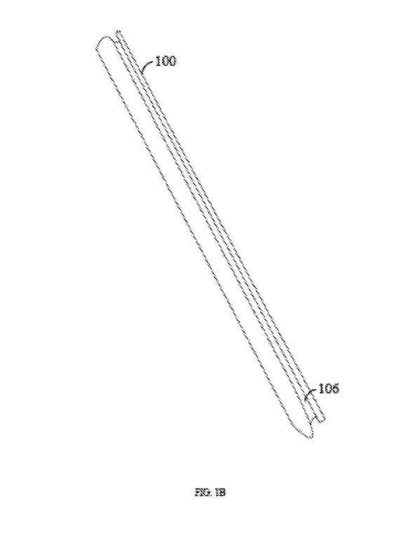

FIGS. 1A and 1B illustrates a block diagram 100 in accordance with an exemplary embodiment of the invention. As shown in FIG. 1A, the device 100 may include one or more earphones cavities 102 for holding the earphones and one or more apertures 104 for operating a camera (not shown). In some implementations, the device 100 may be a phone accessory that can be used with or is sold with wired or wireless earphones (not shown). The earphones cavity 102 and the aperture 104 may appear on any portion of the device. As shown in FIG. 1B, the device 100 may include a channel 106 to wrap wires or cords (not shown) of the earphones (not shown) around the device 100. The channel 106 may be one or more grooves or cavities. As a result of the wraparound of the cords on to the channel 106, the cord may fit hold itself in the channel 106. The device 100 may be made of silicone, plastics, or any material known by those skilled in the art. The device may contain all the functions, openings, vents, plugs, grips, etc. or any cover known by those skilled in the art.

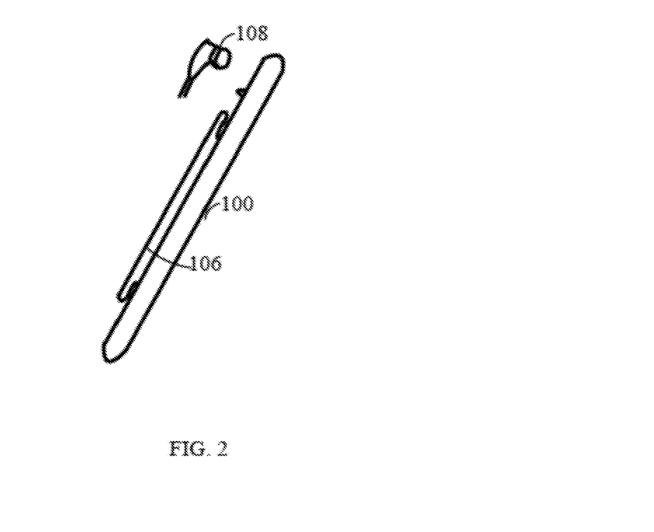

FIG. 2 illustrates a block diagram 100 in accordance with another exemplary embodiment of the invention. As shown in FIG. 2, the device 100 may include earphones 108 that would plug or snap in the earphones cavities 102. The earphones 108 may be earbuds or any earphone device known by those skilled in the art. The earphones cavities 102 may be on any side or portion of the device 100. The earphone cavities 102 may include an eye design or any depiction known by those skilled in the art.

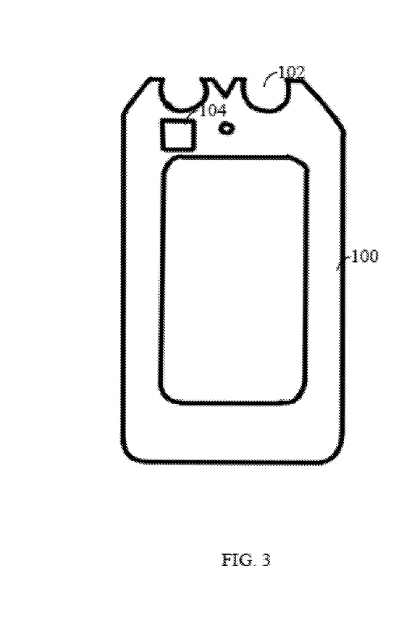

FIG. 3 illustrates a block diagram 100 in accordance with another exemplary embodiment of the invention. As shown in FIG. 3, the device 100 may include one or more earphones cavities 102 for holding the earphones and one or more apertures 104 for operating a camera (not shown). In some implementations, the device 100 may have a detachable portion (not shown) to allow the insertion of earphones (not shown) in the earphones cavities 102.

In some implementations, the system may include a cell phone or smartphone cover. The cell phone cover or smart phone cover may have the dimensions of height, width, thickness, respectively, in the ranges of 0-200 mm and/or 0-100 inches. Alternatively, the system may include a tablet cover. The tablet cover may have may have the dimensions of height, width, thickness, respectively, in the ranges of 0-1000 mm and/or 0-100 inches.

In some embodiments, the phone cover or tablet cover may include an earphones cavity or earphones portion. The earphones cavity or earphones portion may have the cover may have the dimensions of height, depth, diameter, respectively, in the ranges of 0-100 mm and/or 0-100 inches.

In an embodiment, the system may disclose a cell phone holder. The cell phone holder may include a pocket for holding a cell phone, and a housing on the back plate of the cell phone holder for accommodating an earpiece of the cell phone. The housing may be a structure for controlling the extension and retraction of the earpiece cable.

In another embodiment, the system may include a hands-free kit containing an earpiece inside the carrying case. The hands-free talking kit for a cellular phone may include a cellular phone carrying case, an adaptor, and an earpiece set connected to an on/off switch with thin copper wires coated with flexible plastic. The thin copper wires may be installed inside of the carrying case and may be connected to a cellular phone via an earphone jack. In some implementations, the system may include cases and covers for handheld electronic devices. As a result, retractable headpieces and cords may be safely protected from damage when not used.

In yet another embodiment, the system may include a keyed earphone caddy and a carrying case. The keyed storage system may protect digital media devices with a case that includes a storage area for safely and compactly storing an earphone set together. The storage system may hold the accessory at the back panels. Additionally, the plug may not comprise any means to fit tightly into the case to hold the cord in place.

In still another embodiment, the system may include a case that accommodates a portable electronic device. The portable electronic device may be a cellular phone, an accessory, an earphone or, any portable electronic device known to those skilled in the art. The case may include a holder to accommodate the portable electronic device. The holder may include a housing and a back panel; a retractile portion fixed within a panel of the holder all along its peripheral area for allowing at least part of a cable portion of the earphone to be wound around. The retractile portion may include one or more channels and an operable portion to keep the coiled cable portion in the position around the case; and one or more slits to positionably mount the eye-buds at the top portion of the case.

In yet another embodiment, the system may include one or more earpiece sets that include one or more microphone, one or more earpieces, and one or more cords. The earpiece sets can be coiled around the cellular phone carrying case of by an inbuilt channel inside the case, along the perimeter. One end of the earpiece sets may be connected to the cellular phone via one or more earphone jacks. The other end of the earpiece sets may be exposed out of the case.

In still another embodiment, the system may include a cellular phone carrying case that may include a housing and a backing plate. The case may which form a pocket suitable for holding a cellular phone. The case may be made of plastic, silicon, or any material known by those skilled in the art. In some implementations, the case may vary in design such as figures, animals, creatures, people, mascots, or any design known by those skilled in the art. As a result, the rear view, front view, side view, or any portion of the case may include a receptacle portion to hold the earbuds or any accessory of a cell phone device.

In yet another embodiment, the system may include the rear side of a back plate of the housing and an aperture to allow for the camera functionality of a portable device with a camera. The aperture for the camera may be located at any position on the case to allow for use of camera functionality. The back plate may be substantially, partially, or completely open. As a result, a frame is formed to hold the a portable device within a pocket while covering the internal components.

Many different arrangements of the various components depicted, as well as components not shown, are possible without departing from the spirit and scope of the present invention. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Not all steps listed in the various figures need be carried out in the specific order described.

What is claimed is:

1. A device for storing one or more accessories comprising:
a case having one or more earphones cavities to hold one or more earphones;
one or more apertures stored on the case to operate a camera;
and one or more channels stored on the case to wrap up one or more wires of the earphones.

2. The device of claim 1, wherein the case is a smartphone cover.

3. The device of claim 1, wherein the case is tablet cover.

4. The device of claim 1, wherein the device is a phone accessory.

5. The device of claim 1, wherein the earphones are wireless earphones.

6. The device of claim 1, wherein the channel includes one or more grooves.

7. The device of claim 1, wherein the cover has a portion that is plastic.

8. The device of claim 1, wherein the cover has a portion that is silicone.

9. An apparatus for storing one or more accessories comprising:
a case having one or more earphones cavities to hold one or more earphones;
one or more apertures stored on the case to operate a camera; and
one or more channels stored on the case to wrap up one or more wires of the earphones.

10. The apparatus of claim 9, wherein the case is a smartphone cover.

11. The apparatus of claim 9, wherein the case is tablet cover.

12. The apparatus of claim 9, wherein the apparatus is a phone accessory.

13. The apparatus of claim 9 wherein the earphones are wireless earphones.

14. The apparatus of claim 9, wherein the channel includes one or more grooves.

15. A means for storing one or more accessories comprising:
a means for holding a portable electronic device;
a means for holding the earphones;
a means for operating a camera; and
a means for wrapping up the wires of the earphones.

16. The means of claim 15, wherein the means for holding a portable electronic device is a smartphone cover.

17. The means of claim 15, wherein the means for holding a portable electronic device is a tablet cover.

18. The means of claim 15, wherein the means for storing one or more accessories is a phone accessory.

19. The means of claim 15, wherein the earphones are wireless earphones.

20. The means of claim 16, wherein the smartphone cover has a portion that is plastic.
